(19) United States
(12) Patent Application Publication
(10) Pub. No.: US 2026/0149490 A1
(43) Pub. Date: May 28, 2026

(54) TECHNIQUES FOR LOW-COMPLEXITY MESSAGE PASSING

(71) Applicant: Lenovo (United States) Inc., Morrisville, NC (US)

(72) Inventors: Abir Ben Hadj Fredj, Frankfurt am main (DE); Ali Ramadan Ali, Kraiburg am Inn (DE)

(21) Appl. No.: 18/962,888

(22) Filed: Nov. 27, 2024

(51) Int. Cl. H04B 7/0456; H04B 7/06

(52) U.S. Cl. CPC H04B 7/0456; H04B 7/0626

(57) ABSTRACT

Various aspects of the present disclosure relate to techniques for low-complexity message passing. An apparatus is configured to create a precoding matrix for enabling a plurality of combinations of streams of multiplexed layers at a plurality of receiving antennas, wherein the plurality combinations of streams are associated with a plurality of user equipment UEs; transmit the precoding matrix to the plurality of UEs associated with the multiplexed layers; detect a plurality of signals at the plurality of receiving antennas using a factor graph-based detection algorithm, wherein the plurality of signals are encoded using the precoding matrix; and decode the plurality of signals based at least in part on the precoding matrix.

### TECHNICAL FIELD

The present disclosure relates to wireless communications, and more specifically to techniques (e.g., methods, designs) for low-complexity message passing.

### BACKGROUND

A wireless communications system may include one or multiple network communication devices, such as base stations, which may support wireless communications for one or multiple user communication devices, which may be otherwise known as UE, or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

A network equipment (NE) for wireless communication is described. The NE may be configured to, capable of, or operable to create a precoding matrix for enabling a plurality of combinations of streams of multiplexed layers at a plurality of receiving antennas, wherein the plurality combinations of streams are associated with a plurality of user equipment UEs; transmit the precoding matrix to the plurality of UEs associated with the multiplexed layers; detect a plurality of signals at the plurality of receiving antennas using a factor graph-based detection algorithm, wherein the plurality of signals are encoded using the precoding matrix; and decode the plurality of signals based at least in part on the precoding matrix.

A method for wireless communication performed by a NE. The method may be configured to create a precoding matrix for enabling a plurality of combinations of streams of multiplexed layers at a plurality of receiving antennas, wherein the plurality combinations of streams are associated with a plurality of user equipment UEs; transmit the precoding matrix to the plurality of UEs associated with the multiplexed layers; detect a plurality of signals at the plurality of receiving antennas using a factor graph-based detection algorithm, wherein the plurality of signals are encoded using the precoding matrix; and decode the plurality of signals based at least in part on the precoding matrix.

A processor for wireless communication is described. The processor may be configured to, capable of, or operable to create a precoding matrix for enabling a plurality of combinations of streams of multiplexed layers at a plurality of receiving antennas, wherein the plurality combinations of streams are associated with a plurality of user equipment UEs; transmit the precoding matrix to the plurality of UEs associated with the multiplexed layers; detect a plurality of signals at the plurality of receiving antennas using a factor graph-based detection algorithm, wherein the plurality of signals are encoded using the precoding matrix; and decode the plurality of signals based at least in part on the precoding matrix.

A user equipment (UE) for wireless communication is described. The NE may be configured to, capable of, or operable to receive a precoding matrix for enabling a plurality of combinations of streams of multiplexed layers, encode a signal using the precoding matrix, the signal combined with signals from a plurality of different UEs associated with the multiplexed layers, and transmit the encoded signal.

Another method for wireless communication performed by a NE. The method may be configured to receive a precoding matrix for enabling a plurality of combinations of streams of multiplexed layers, encode a signal using the precoding matrix, the signal combined with signals from a plurality of different UEs associated with the multiplexed layers, and transmit the encoded signal.

Another processor for wireless communication is described. The processor may be configured to, capable of, or operable to receive a precoding matrix for enabling a plurality of combinations of streams of multiplexed layers, encode a signal using the precoding matrix, the signal combined with signals from a plurality of different UEs associated with the multiplexed layers, and transmit the encoded signal.

### BRIEF DESCRIPTION OF THE DRAWINGS

FIG. 1 illustrates an example of a wireless communications system, in accordance with aspects of the present disclosure.

FIG. 2 illustrates an example of a non-orthogonal multiple access (NOMA) transmitter process, in accordance with aspects of the present disclosure.

FIG. 3 illustrates an example of spreading sparse code multiple access (SCMA) codewords over multiple resources, in accordance with aspects of the present disclosure.

FIG. 4 illustrates an example multi-user multi-user multiple-input multiple-output (MU-MIMO) SCMA network, in accordance with aspects of the present disclosure.

FIG. 5 illustrates an example MU-MIMO SCMA using linear precoding at transmitter, in accordance with aspects of the present disclosure.

FIG. 6 illustrates an example of message passing algorithm (MPA) complexity reduction gains, in accordance with aspects of the present disclosure.

FIG. 7 illustrates an example of MU-MIMO SCMA clustering, in accordance with aspects of the present disclosure.

FIG. 8 illustrates an example of a user equipment (UE) in accordance with aspects of the present disclosure.

FIG. 9 illustrates an example of a processor in accordance with aspects of the present disclosure.

FIG. 10 illustrates an example of a network equipment in accordance with aspects of the present disclosure.

FIG. 11 illustrates a flowchart of a method in accordance with aspects of the present disclosure.

FIG. 12 illustrates a flowchart of a method in accordance with aspects of the present disclosure.

### DETAILED DESCRIPTION

A wireless communication system may support factor graph-based algorithms. In TR 38.812 (incorporated herein by reference), various NOMA schemes are discussed for 5G standardization. The benefit of having a NOMA scheme, especially in terms of uplink, is that it enhances the sum throughput and system capacity. To deal with interference caused by the non-orthogonal transmissions using overlapping resources, the transmitter side uses schemes such as spreading and interleaving.

NOMA schemes may be divided into two categories—code domain NOMA and power domain NOMA. SCMA remains one of the promising code domain NOMA techniques, which merges quadrature amplitude modulation (QAM) mapping and spreading and encodes incoming bits into sparse N-dimensional codewords that are drawn from a user-specific sparse codebook.

At the receiver side, a MPA can iteratively detect the multiplexed SCMA codewords. However, MPA has a slow convergence rate, and the complexity increases exponentially with the size of the codebook, the number of multiplexed layers, and the number of transmit (Tx)/receive (Rx) antennas, which reduces the effectiveness of SCMA. Some complexity-reduced MPA detectors have been proposed, among which the MPA detector based on dynamic factor graph (DFG-MPA) has been shown to outperform other MPA detectors with comparable complexities. However, MPA detectors may not provide flexibility in terms of performance-complexity trade-off, i.e., the granularities of computational complexity reduction are relatively large.

The subject matter discussed herein presents apparatuses, methods, systems, and procedures to enable low complexity MPA for SCMA detection in MU-MIMO systems using precoding techniques. The presented solutions allow for faster MPA convergence as well as reduced complexity computations per iteration. This enables the detection of multiplexed layers in overloaded SCMA systems using low-complexity procedures. The proposed solutions enable the decoding of different factor graphs (FGs) starting from the least connected to the most connected, which allows one or more variable nodes of the FG to be associated with high likelihoods thanks to the spatially orthogonal streams made possible through MU-MIMO and precoding. The precoding matrix could be designed by the BS and is performed over multiplexed layers.

The subject matter herein details procedures for enabling a low-complexity MPA by leveraging additional reliable information about one or more variable nodes within the FG. The additional reliable side-information is obtained using precoding at the transmitters and post-coding at the receiver. In this disclosure, MU-MIMO spatial diversity is leveraged to enable low complexity detection instead of higher spectral efficiency and higher capacity. A precoding matrix is applied to the multiplexed layers/UEs and the received signals at the receiver are composed of the signal of superposed symbols at a first receiving antenna and one or more signals representing one or more layers or combination of a subset of layers from the multiplexed layers at different receiving antennas. Signals received at different antennas are made orthogonal using linear precoding techniques.

In one embodiment, a result of the solutions proposed herein is to reduce an MPA's complexity by ensuring faster convergence and less iterations such that the probabilities converge to a codeword in less iterations than conventional processing. Another result of the solutions proposed herein is, at each iteration, probabilities that include channel samples and messages received from FNs or VNs could be made simpler if one or more of the VNs is/are known with high likelihoods, which allows detecting users when there are high overloaded systems and high order FGs.

In one embodiment, a solution is directed to handling UEs (e.g., multiplexed layers) as a base station (BS) with multiple Tx antennas in a MU-MIMO scenario, where cooperative linear precoding could be applied to each user's signal to have at the receiver (BS), one signal y that represents the superposition of different UE signals and one or more additional signals (bounded by the channel matrix rank, e.g., the number of singular values that remain in the matrix and/or the number of linearly independent rows or columns), namely y₁ and y₂, that would be additionally used in the iterative decoder as channel samples that represent a single UE's signal from the one or more multiplexed UEs or detected in a less connected FG based detection scheme.

In one embodiment, a precoder is discussed that has low complexity, where each row of the precoding matrix is applied to one of the multiplexed users, allowing different independent streams at the receiver.

Accordingly, the solutions proposed herein reduce the complexity of MPA detection by reducing the number of iterations needed for the algorithm's convergence and by reducing the complexity of computations per iteration.

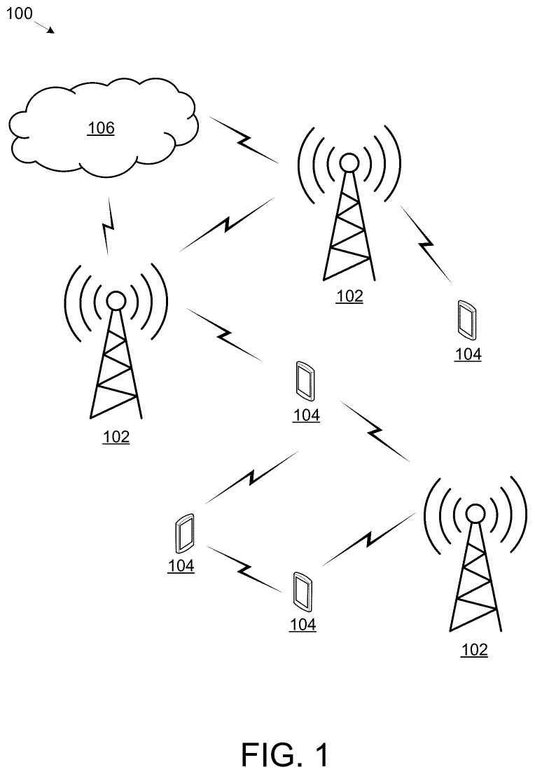

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In one embodiment, the system 100 shown in FIG. 1 is configured to, capable or, or operable to create a precoding matrix for enabling a plurality of combinations of streams of multiplexed layers at a plurality of receiving antennas, wherein the plurality combinations of streams are associated with a plurality of user equipment UEs; transmit the precoding matrix to the plurality of UEs associated with the multiplexed layers; detect a plurality of signals at the plurality of receiving antennas using a factor graph-based detection algorithm, wherein the plurality of signals are encoded using the precoding matrix; and decode the plurality of signals based at least in part on the precoding matrix.

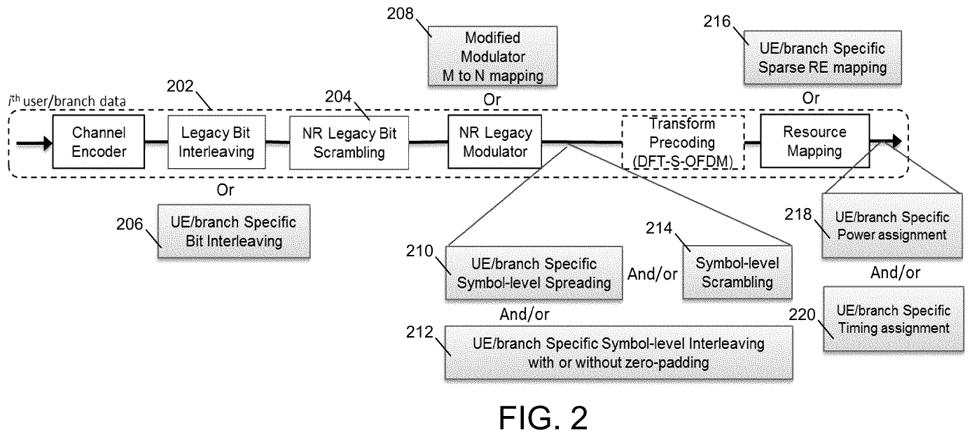

FIG. 2 illustrates an example of a NOMA transmitter process, in accordance with aspects of the present disclosure. In one embodiment, the conventional NR design 202 is modified or enhanced with blocks 206-220, which are described in more detail below. It should be noted that the initialization seed for the legacy bit-scrambling sequence generation 204 can be updated, which may involve certain specification impact.

NOMA transmission side processing is characterized by multiple access (MA) signature and auxiliary features. MA signature is typically used to differentiate users. In this subclause, MA signatures are described more from the perspective of traffic data.

NOMA is distinct from Orthogonal Multiple Access (OMA), which allocates users in orthogonal dimensions such as time and frequency, as seen in time division multiple access (TDMA) and frequency division multiple access (FDMA). NOMA, conversely, combines users within the same time-frequency resources using either the power or code domain.

According to power-domain NOMA, superposition coding (SC) is applied at the transmitter, and successive interference cancellation (SIC) is performed at the receivers. This approach, known as SC-SIC, is motivated by its ability to achieve the capacity region of the single-input single-output (SISO) Gaussian broadcast channel. This capacity region is larger than what OMA (e.g., TDMA) can achieve when users have varying channel strengths. However, when users have similar channel strengths, OMA based on TDMA is sufficient to attain the capacity region. Another well-known technique is space division multiple access (SDMA), which superimposes users on the same time-frequency resources and differentiates each user along the spatial domain using multi-user linear precoding. Another technique may be referred to as multi-antenna NOMA, which consists of ordering users based on their effective scalar channel strengths (post-precoding) and enforces the receivers to decode messages in a successive manner. This results in one receiver decoding messages based on a single-antenna degraded channel.

TABLE 1
Overview of Advantages and Disadvantages of NOMA

| | |
|---|---|
| Advantages | Disadvantages |

Single-antenna NOMA Broadcast Channel

| | |
|---|---|
| Overload Handling: Capability to cope with an | Scalability: In a K-user SISO Broadcast |
| overloaded capacity regime in a spectrally | Channel (BC), the user with the best channel |
| efficient manner, wherein multiple users have | must employ SIC to decode the messages of all |
| different channel characteristics including | other K - 1 co-scheduled users before accessing |
| varying reference signal received power | its own intended data stream. While SIC for a |
| (RSRPs)/path losses on the same time- | small number of layers is manageable in |
| frequency resource. | practical terms, the complexity and the risk of |
| | error propagation become notably challenging |
| | as the number of users increases. |

Spatial Division Multiple Access

| | |
|---|---|
| Spatial Multiplexing Gain: Take advantage of | Overload Handling: Performs well in an |
| the spatial multiplexing gain based on the | underloaded capacity regime, however the |
| knowledge of perfect channel state information | performance drops in an overloaded regime and |
| (CSI) and lower receiver complexity | requires more Tx antennas at the gNB than users |
| | served in a cell to manage multi-user |
| | interference. Conventional approaches would be |
| | to schedule groups of users over orthogonal |
| | resources and perform linear precoding in each |
| | group. This approach can increase overall |
| | latency. |
| | User Grouping: Its effectiveness depends on the |
| | degree of user channel orthogonality and their |
| | channel conditions, e.g., signal strengths, |
| | necessitating the scheduler to group users with |
| | moderately similar channel strengths. If an |
| | exhaustive search is conducted, the scheduler's |
| | complexity can rise significantly, but there are |
| | also less complex (though not optimal) |
| | scheduling and user-pairing algorithms |
| | available. |
| | Imperfect CSI: Its optimality diminishes when |
| | dealing with imperfect CSI. The challenge in |
| | designing multi-user linear precoding (MU-LP) |
| | in imperfect CSI at transmitter (CSIT) scenarios |
| | has typically involved adapting a framework |
| | originally designed for perfect CSIT, rather than |
| | developing a framework tailored from the outset |
| | for imperfect CSIT. This approach has resulted |
| | in significant performance degradation for MU- |
| | LP when imperfect CSIT is present |

Multi-Antenna NOMA Broadcast Channel

| | |
|---|---|
| Overload Handling: Similar to the SISO case, it | Degree of Freedom Loss: Users are ordered on |
| has the capability to cope with an overloaded | channel strengths to achieve the capacity region |
| capacity regime in a spectrally efficient manner, | which limits the spatial multiplexing gains |
| wherein multiple users have different channel | offered by multi-antenna systems. |
| characteristics including varying RSRPs/path | Higher Complexity: Utilizing multi-antenna |
| losses on the same time-frequency resource. | NOMA introduces higher complexity at both the |
| | transmitter and the receivers. Unlike single- |
| | antenna NOMA, multi-antenna NOMA requires |
| | a multi-layer SIC process at the receivers. |
| | Furthermore, since multi-antenna NOMA is |
| | vector-based as opposed to scalar-based, it lacks |
| | a natural order for arranging user channels. |
| | Consequently, the scheduler at the transmitter |
| | must jointly optimize three aspects including |
| | precoders, user groups, and decoding orders. |
| | For example, when applying NOMA with “SC- |
| | SIC” to a three-user Multiple-Input Single- |
| | Output (MISO) BC, the optimization involves |
| | three precoders (one for each user) and |
| | consideration of six possible decoding orders. |
| | As the number of users increases, the potential |
| | decoding orders grow exponentially. |
| | Imperfect CSI: Similar to SDMA, it also |
| | vulnerable to imperfect CSI since the original |
| | design is based on the perfect CSI assumption. |

Low density spreading (LDS) is a special case of SCMA. LDS as a form of multi-carrier CDMA (MC-CDMA) is used for multiplexing different layers of data. As opposed to SCMA with multi-dimensional codewords, LDS uses repetitions of the same (QAM) symbol on layer-specific nonzero position in time or frequency. As an example, in LDS-orthogonal frequency division multiplexing (LDS-OFDM) a constellation point is repeated (with some possible phase rotations) over nonzero frequency tones of an LDS block. The shaping gain and coding gain of multi-dimensional constellations is one of the advantages of SCMA over LDS. The gain is potentially high for higher order modulations where the repetition coding of LDS shows a large loss and poor performance.

SCMA is an evolution of LDS. In contrast to orthogonal multiple access (OMA) schemes such as OFDMA where each user has a dedicated resource (subcarrier), LDS allows multiple users to simultaneously share the same resource. In the case of LDS, repetition code is used, and each user transmits the same QAM symbol over different resources. The LDS scheme could be represented by a bipartite graph (known as FG), which could be associated with a signature matrix.

A graph is composed of vertices (or nodes) and edges. Two nodes are connected with an edge when there is some relationship between them. Different types of graphs are used to model problems in areas such as computer science, biology, physics, etc. A widely known graph for modelling communication and signal processing problems is called a bipartite graph. In this graph, the total nodes can be divided into two sets and no two nodes within a set are connected to each other.

An FG is an undirected bipartite graph in which one set of nodes is called variable nodes (VNs) and the other called function nodes (FNs). An edge is connected between a variable node and a function node if that variable is an argument of that function. FG shows how a global function can be represented in terms of simpler local functions (FNs) and can also help in computing marginal distribution with respect to single variable using sum-product algorithm (SPA). SCMA follows the same design concepts of LDS; however, the main difference is that SCMA allows the use of multi-dimensional constellations instead of repetition coding which results in a more than 1 dB shaping gain.

By contrast to LDS, QAM mapping and spreading are merged together in SCMA and therefore several incoming bits (of certain user) can be directly mapped to a sparse complex vector (codeword) which is drawn from its associated sparse codebook. Due to the sparsity of the codebooks, the multiuser signals can be efficiently detected and recovered at the receiver with the aid of message passing algorithm (MPA) whose error rate performance approaches that of a maximum a posteriori (MAP) detector.

The SCMA FG has three important parameters which are an overloading factor, dover, which represents the number of users/number of subcarriers; a multiplexing factor, de, which represents the number of symbols multiplexed on each subcarrier; and a spreading factor, dᵥ, which represents the number of subcarriers each symbol is spread over.

In general, there are two major research lines associated with SCMA—codebook (CB) design and multiuser detection (MUD). Consider a network, where J users transmit uplink data to a base station using K resource elements (e.g. time, frequency-slots). The SCMA system is assumed to be perfectly synchronous. In SCMA, the data/input bits of user are mapped to a complex codeword using the SCMA encoder.

For instance, if user j wants to transmit bj bits, the encoder will map these bⱼ bits to a codeword mⱼ selected from a pre-defined codebook CBⱼ:

$${m}_{j} = {CB}_{j} ( {b}_{j} )$$

Where mⱼ∈ [symbol] ⊂ [symbol] , where [symbol] denotes the set of codewords of the j^{th} user.

A SCMA encoder has J layers and there is a specific codebook (CB) dedicated to each user. Assume one layer per user, where ‘user’ and ‘layer’ are used interchangeably. The performance gain of SCMA over other NOMA schemes is strongly dependent on well-designed sparse codebooks. The codebook of each user has its own sparsity pattern and can be written as a matrix of size K×M, where M denotes the number of codewords (i.e., columns of a CB matrix) allotted to a user. In a CB, each column vector (i.e., codeword) is sparse, consisting of dᵥ non-zero elements at certain fixed resources elements (REs) pertinent to a specific user. Conventional codebook designs that are based on a multi-stage approach are mostly sub-optimal.

For the j-th user, multidimensional codebooks can be expressed as

$${CB}_{j} = {V}_{j} {Δ}_{j} {A}_{M C}^{′}$$

Where Vⱼ∈ [symbol] denotes the binary mapping matrix,

$${A}_{M C}^{′}$$

denotes the multi-dimensional mother constellation and Δⱼ refers to the constellation operator for the j-th user, respectively. The mapping matrix is selected in such a way that each user has active transmissions over a few fixed REs.

Unitary rotations may be applied to a mother constellation to increase power variation among different users in order to reinforce the “near-far effect” for suppression/mitigation of multiuser interference as well as to enhance the constellation shaping gain. Once the mother constellation is designed, layer-specific operations are applied to generate multiple CBs for different users. These operations may include phase rotation, complex conjugate, layer power offset, and dimensional permutation.

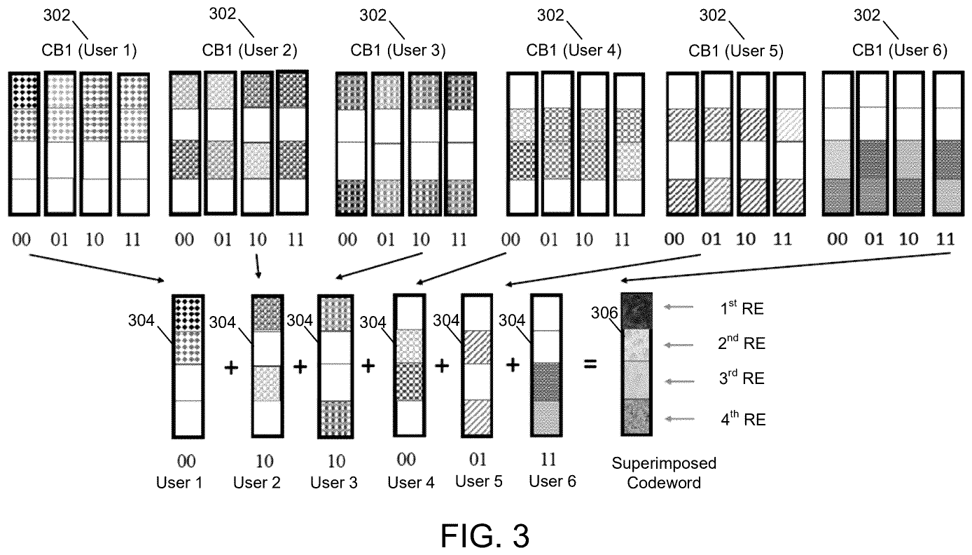

FIG. 3 illustrates an example of spreading SCMA codewords over multiple resources, in accordance with aspects of the present disclosure. In one embodiment, codewords 304 from different users 302 are selected and combined to create a superimposed codeword 306 that is spread across multiple REs.

Consider a symbol-synchronous uplink SCMA system where J users communicate over K resource elements (REs). Let mⱼ be the transmitted codeword of the j-th user, where mⱼ∈ [symbol] has cardinality M=2^{b} with b denoting the number of bits per codeword. Let us consider a (4,6) SCMA system with M=4, i.e., each codebook has 4 codewords that are mapped to two binary bits. For an uplink SCMA system, let hⱼ=[h₁ⱼ, . . . h_{KJ}] be the effective channel fading coefficient for the j-th user, where hₖⱼ denotes the channel fading coefficient at the kth RE for the jth user. Let mⱼ=[C_{1,J}, . . . , C_{K,J}] be the transmitted codeword of the j-th user, where C_{k,J} be the codeword element transmitted by the j-th user on the k-th RE. The received signal at the base station is:

$$y = {\sum }_{j = 1}^{J} diag ( {h}_{j} ) {m}_{j} + n$$

where n∈ [symbol] is the noise vector, each element of which can be modelled as complex Gaussian distribution [symbol] (O, σ²). Due to the sparse nature of SCMA codebooks, non-zero values from d_{c} out of J number of users overlap over each RE and also each user data is transmitted on dᵥ<K resource elements.

At the receiver, the objective of an optimal detector is to minimize the probability of error (P(e)) for the transmitted bit sequence x, i.e., to minimize the mismatch between transmitted bits (x) and estimated bits (\dot{x}):

$$min ( P ( e ) ) = min ( P ( x \neq \dot{x} ) )$$

MPA, as used herein, is an algorithm to conduct inference from graphical models by passing belief messages between the nodes. In SCMA systems, each VN denotes one data layer, and each FN denotes the likelihood function at the resource element (RE). Therefore, the total number of VNs is equal to the total number of layers/users and the total FNs equals the total REs present.

Suppose the transmitted bits are c=[c₁; c₂; . . . ; c_{N}] and received bits are y=[y₁; y₂; . . . ; y_{N}], then the aim is to compute the a posteriori probability (APP) of bit cᵢ, i.e., P(cᵢ=0/y): Using Bayes' rule, the APP ratio with regard to cᵢ can be converted into likelihood ratio as follows:

$$\frac{P ( {c}_{i} = 0 / y )}{P ( {c}_{i} = 1 / y )} = \frac{f ( y / {c}_{i} = 0 )}{f ( y / {c}_{i} = 1 )}$$

Taking natural logarithm, we obtain the Log-likelihood ratio (LLR) of cᵢ below:

$$LLR ( {c}_{i} ) = log ( \frac{f ( y / {c}_{i} = 0 )}{f ( y / {c}_{i} = 1 )} )$$

If LLR(cᵢ)<0, then cᵢ=1 is decoded otherwise 0.

Message passing in an FG using SPA is an iterative process if the FG has cycles (closed loops) present in it. In every iteration, there are two steps. In Step 1, a belief message is passed from a variable node (VN) to a function node (FN) and in Step 2, the message is passed from an FN to a VN, respectively.

Step 1: Suppose there is a VN j₁ which has connections with 3 FNs with indices k₁; k₂; k₃. To pass a message from VN j₁ to FN k₂, firstly VN j₁ multiplies all the messages received from its neighboring nodes except FN k₂ (i.e., k₁ and k₃) and then transfer the output to FN k₂.

Here, nⱼ_{₁}_{→k}_{₂} indicates the belief message from VN j₁ to FN k₂. The outgoing message from a VN is in the form of either P(cᵢ=0/y) or APP ratio or likelihood ratio.

Step 2: In this step, a belief message is passed from an FN to a VN. Consider a FN k₁ which has three neighboring VNs (j₁; j₂; j₃). To send a belief message from FN k₁ to VN j₂, FN k₁ first collects all the messages from its neighboring nodes except for VN j₂. These received messages are multiplied with the local function ƒₖ_{₁}(j₁, j₂, j₃) associated with FN k₁ and then the resulting function is marginalized with respect to VN j₂. After marginalization, the resulting message to be sent to VN j₂ can be expressed as follows:

$${n}_{{k}_{1} \to {j}_{2}} = {\dot{\sum }}_{\sim {j}_{2}} ( {f}_{{k}_{1}} ( {j}_{1} , {j}_{2} , {j}_{3} ) {n}_{{j}_{1} \to {k}_{1}} {n}_{{j}_{3} \to {k}_{1}} )$$

Here ƒₖ_{₁}(j₁, j₂, j₃) indicates the local function of FN k₁ and message nₖ_{₁}_{→j}_{₂} indicates P(k₁ function is satisfied messages received at FN k₁), respectively. Similarly, if a belief message needs to be passed from FN k₁ to VN j₃, then the belief message from the VNs j₁ and j₂ (all VNs except the one to which message needs to be passed) is considered as extrinsic information.

Through spatial diversity, multiplexing or beamforming gain, the MIMO techniques can offer significant performance improvements in terms of user capacity, spectral efficiency, and peak data rates. Recently, the application of MIMO techniques along with NOMA has aroused great interest as an enabling technology to meet the exacting demands of 5G and beyond 5G (B5G) wireless networks. In effect, by allowing multiple users to access overlapping time and frequency resources in the same spatial layer, NOMA has the potential to provide higher system throughput and solve the massive connectivity needed for future wireless networks.

In SCMA, user information bits are converted into sparse multidimensional codewords using a 3D codebook. As stated in the previous section, SCMA technology allows to increase the spectral efficiency, number of user connections, and bit error rate (BER) performance compared to other existing access methods. Another technology capable of increasing the spectral efficiency of communication system is MIMO. MIMO involves the use of multiple antennas at the transmitter and/or receiver. Systems with the combined use of MIMO and SCMA technologies can improve the performance of single-antenna SCMA systems. By using MIMO as spatial multiplexing, it is possible to increase the transmission rate in MIMO-SCMA systems several times. The MIMO-SCMA system could be obtained by extending equation to T transmitting and R receiving antennas. Hence, the received signal at each antenna (i) could be expressed as:

$${Y}^{( i )} = {\sum }_{j = 1}^{T} {H}^{( i ) , ( j )} {X}^{( j )} + {N}^{( i )}$$

Where H is the channel matrix of dimension KR×KT and N is an additive white Gaussian noise of dimension KR×1.

As a novel NOMA scheme for 5G systems, SCMA features multi-dimensional sparse codebooks, which enables it to achieve shaping gain and use MPA as the multiuser detector. It is shown that the MPA detector can obtain nearly optimal performance with a feasible computational complexity. However, the MPA detector exhibits a computational complexity exponential in the number of superimposed users on resource nodes (RNs). This makes the MPA detector less attractive for systems with a lot of users.

To overcome this difficulty, various complexity reduced MPA detectors have been proposed to offer a trade-off between performance and complexity. The subject matter herein discusses modified MPA detectors with better and more flexible performance-complexity trade-offs. Different approaches have been attempted to reduce the computational complexity of the MPA multiuser detector for SCMA systems. Serial schedules may be used to speed up the convergence rate of the MPA detector. The basic idea is to use earlier updated messages in the updates of later messages at the same iteration, thus accelerating the convergence speed. Simulation results have shown that optimized serial schedules can halve the number of iterations or even more. However, due to the serial nature, such serial schemes may not meet the low latency requirements in delay sensitive applications.

Therefore, a low complexity parallel MPA multiuser detection schemes design may be needed. In an MPA detector based on partial marginalization scheme, after a few iterations, t symbols are selected and determined in advance. Then, in the rest of the iterations, computations are not required for these t symbols to reduce the computational complexity. Motivated by the idea of sphere decoding (SD), a complexity-reduced MPA, called SD-MPA has been developed, which works by considering superposed constellation points within a sphere centred at the received signal. A low complexity MPA detector based on DFG has been proposed, which reduces the complexity by progressively prohibiting the updates of a fixed number of reliable messages from some iteration onwards. This procedure can be equivalently viewed as dynamically modifying the underlying SCMA FG, thus termed as dynamic FG-based message passing (MP) detection. DFG-MPA may provide a much better trade-off between performance and complexity than both PM-MPA and SD-MPA.

Although DFG-MPA outperforms the other complexity-reduced MPA detection schemes in terms of performance and complexity trade-off, it suffers from a non-negligible BER performance loss compared to the original MPA. To mitigate the performance loss while maintaining its low complexity, a generalized scheme of DFG-MPA (GDFG-MPA) may be used. To narrow the performance gap, instead of banning the message update of a directional edge from some iteration onwards, a message without updating at some iteration is allowed to be updated at later iterations in the proposed scheme. Moreover, different numbers, rather than a fixed number, of messages are allowed to be banned from updating at different iterations. Under this scheme, optimization of DFG-MPA is possible and can be carried out by allocating different numbers of banned messages at different iterations.

In one embodiment, different streams are received at each of the receiving antennas. The streams are composed of combinations (superposition) of different multiplexed layers. The NOMA detector could, in this case, start by detecting UEs within the least connected FGs and move gradually to the most connected FG by inserting the high likelihoods of detected VNs within the next connected FG. As used herein, likelihood may refer to the probability of some observed outcomes given a set of parameter values −P(x/y,z). High likelihood means high conditional probability P(x/y,z). Further, the connectedness of an FG (least or most) may refer to the number of connections between VNs and FNs.

In one embodiment, the complexity of the MPA could be reduced by inserting high likelihoods associated with detected VNs within the FG. In this case, MU-MIMO precoding is used to create additional side information for the iterative MPA detection algorithm. The side information has a high likelihood that would be leveraged to maximize the a-posteriori probability in less iterations and that would reduce the complexity of the computations per iteration.

In one embodiment, the precoding matrix could be designed such that the received signals at the receiver/BS are composed of one signal corresponding to the superposition of transmitted signals from multiplexed layers received at first antenna element. Different signals from single multiplexed UEs are received on one or more different antenna elements. The precoding would make the FG associated with the detection sparser and would enable the crafting of high likelihood VNs.

According to the first implementation, the precoding matrix could be designed to allow singular value decomposition (SVD) of the channel matrix given perfect CSI at the BS, e.g., a process that allows the decomposition of the channel matrix into two unitary matrices and a diagonal matrix and which results in the creation of orthogonal streams at the receiver. As used herein, perfect CSI may refer to a situation where a CSI value that satisfies an accuracy threshold, then it is “perfect”. The BS could then configure each of the multiplexed SCMA layers/users by one of the precoding matrix's rows as follows:

$${s}_{1}^{P} = {P}_{1} {s}_{1}$$

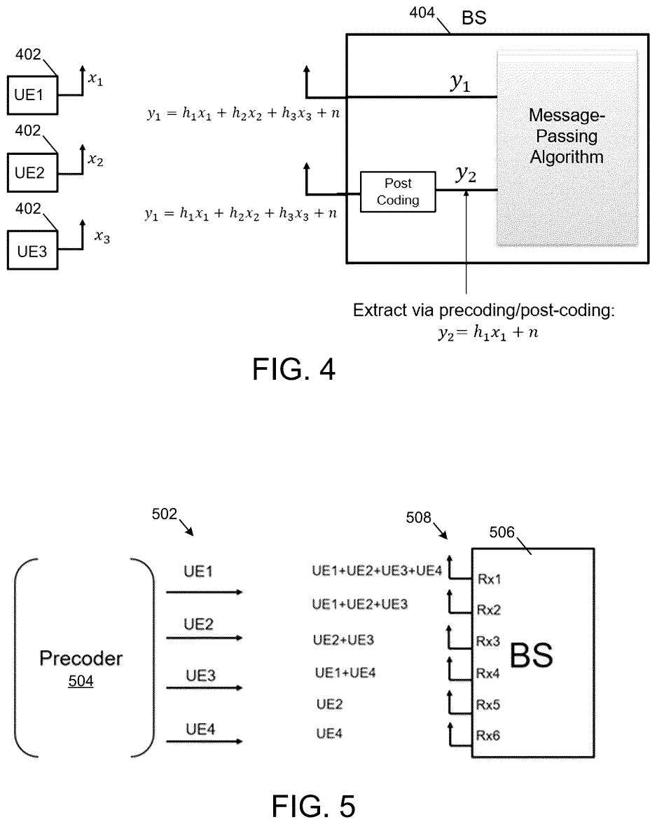

FIG. 4 illustrates an example MU-MIMO SCMA network, in accordance with aspects of the present disclosure. In one embodiment, a number of UEs 402 equipped with a single antenna-transmitter are multiplexed over the same resources, where a precoding matrix is designed by the BS 404 based on perfect CSI and applied to each UE 402 from the multiplexed UEs 402.

In one embodiment, the pre-processing could enable the convergence of iterative decoding in less iterations as well as reducing the complexity of computations per iteration. This enables gains in terms of energy consumption at the BS.

In another embodiment, the precoder matrix could be designed as a combination of submatrices composed of SVD, matched filtering (MF) (a technique for nullifying a UE's signal at the receiver), zero forcing (ZF) (a technique for nullifying a UE's signal at the receiver), or a combination thereof.

As illustrated in FIG. 4, the MU-MIMO SCMA scheme is configured with M UEs 402, each UE 402 having one transmit antenna and a BS 404 with multiple receive antennas Nᵣ. The UEs' multi-dimensional symbols

$${s}_{k} = [ {s}_{1}^{k} , {s}_{2}^{k} , … . , {s}_{J}^{k} ]$$

are spread over different orthogonal REs, for example, OFDMA spectral tones. J users/layers are multiplexed over the same REs. On the RE k∈[1, Rₑ], the received signal could be written as follows:

$${y}_{k} = {H}_{k} {s}_{k} + {w}_{k}$$

Where Wₖ∈ [symbol] is an additive white Gaussian noise with

$$\begin{matrix}𝔼 [ {w}_{k} ] = 0 and \\ 𝔼 [ {w}_{k} {w}_{k}^{H} ] = {N}_{0} {I}_{{N}_{r}} and {H}_{k} ∈ {ℂ}^{{N}_{u} \times {N}_{r}}\end{matrix}$$

is the uncorrelated Rayleigh channel matrix. The FG associated with each RE is depicted in FIG. 5.

In another embodiment, the MU-MIMO precoder could be a linear precoder such as the SVD, maximum ratio transmission (MRT) (a technique for combining multiple signals using a precoder), ZF, or the like, or a non-linear precoder, e.g., for dirty paper coding (DPC) (a technique for efficient transmission of digital data through a channel subjected to some interference known to the transmitter where the data is precoded to cancel the interference), or the like

In one embodiment, the precoding matrix is applied at the transmitters by multiplying each transmitted signal of the multiplexed layers by one row of the precoding matrix such that the received signal is as follows:

$${y}_{k} = {H}_{k} {P}_{k} {s}_{k} + {w}_{k}$$

The linear precoder Pₖ could be an SVD precoder which enables the transformation of the channel matrix Hₖ to:

$${H}_{k} = U {\sum }_{k} {V}^{*}$$

At the receiver/BS, i∈[|1, Nᵣ|], i<Nᵣ Rx antennas could receive the superposed SCMA codewords from different UEs and j∈[|1, Nᵣ|], j<Nᵣ could apply post-coding over the precoded SCMA codewords received from multiplexed orthogonal UEs:

$$\{ \begin{matrix}{y}_{i} = {H}_{i} {s}_{i} + {w}_{i} \\ {y}_{j} = U {\sum }_{j} {V}^{*} {s}_{j} + {w}_{j}\end{matrix}$$

After post-coding at the receiver/BS, yⱼ could be written as follows:

$${y}_{j}^{′} = {UV}^{*} {s}_{j} + {w}_{j}$$

This creates different FGs at the receiver that could be merged into one FG where one or more variable nodes are characterized by high likelihood probabilities which enable the convergence of the iterative detector in less iterations and the complexity reduction of the computations per iteration.

From this a posteriori probability, an FG can be drawn to represent the link between each variable (VNs) connected through functions (FNs). The FG is the support on which MPAs are applied to compute an approximation of MPAs exchange messages along the edges of an FG, and the more edges there are, the more complex the detection becomes, e.g. the computational complexity increases exponentially based on the number of users connected to a single RE and the number of REs.

FIG. 5 illustrates an example MU-MIMO SCMA using linear precoding at transmitter, in accordance with aspects of the present disclosure. At the base station 506, the input of each receiving antenna 508 is composed of different combination of signals that represent a different FG starting from the least connected the most connected FG.

In one embodiment, the precoding matrix 504 could be designed and configured by the BS 506 having perfect CSI. In this case, each UE 502 from the multiplexed UEs could provide its CSI as feedback to the BS 506 prior to transmitting the SCMA codewords. Prior to transmission, channel training could be performed by the BS 506 to acquire CSI related to the channel between the BS 506 and the multiplexed layers. This procedure could be done for the group of multiplexed layers when the channel changes, for example, in a block fading channel scenario once per block.

In an alternate embodiment, the receiver could be composed of a post-processing bloc and parallel FGs. The post-processing bloc, in one embodiment, is a post-coder that enables the retrieval of the different streams.

In a second embodiment, FG based SCMA detection is performed independently on each received and retrieved stream. In this case, the MPA detection is applied starting at the least connected FG and goes to the most connected FG and, by adopting SIC, the iterative detection could converge in less iterations. In one embodiment, SIC enables the decoding of VNs, successively cancelling VNs, and gradually shrinking the FGs. This is possible if an equivalent channel matrix is considered where the equivalent channel matrix includes the effective channel matrix, the base constellation (e.g., the fundamental set of possible signal points that represent the underlying modulation scheme used to transmit data through the channel, essentially describing the distribution of possible signal values on a constellation diagram when considering the channel's ideal, unperturbed state, before any channel effects are applied) used by all multiplexed UEs as well as the applied rotation to each UE and to each RE:

$${H}^{eq} = \overline{H} ⊙ \overline{G}$$

Where H is the rearranged channel matrix, Q is the Hadamard product and G is the constellation rotation matrix which could written as follows:

$$\overline{G} = G ⊗ {𝕀}_{{N}_{r}}$$

Where ⊗ is the Kronecker product and [symbol] is the vector of ones of size Nᵣ.

In this case, the a-posteriori probability could be defined as:

$$ℙ ( x \vert y , H ) = {\prod }_{j = 1}^{{N}_{r}} ℙ ( y \vert x , H ) ℙ ( x )$$

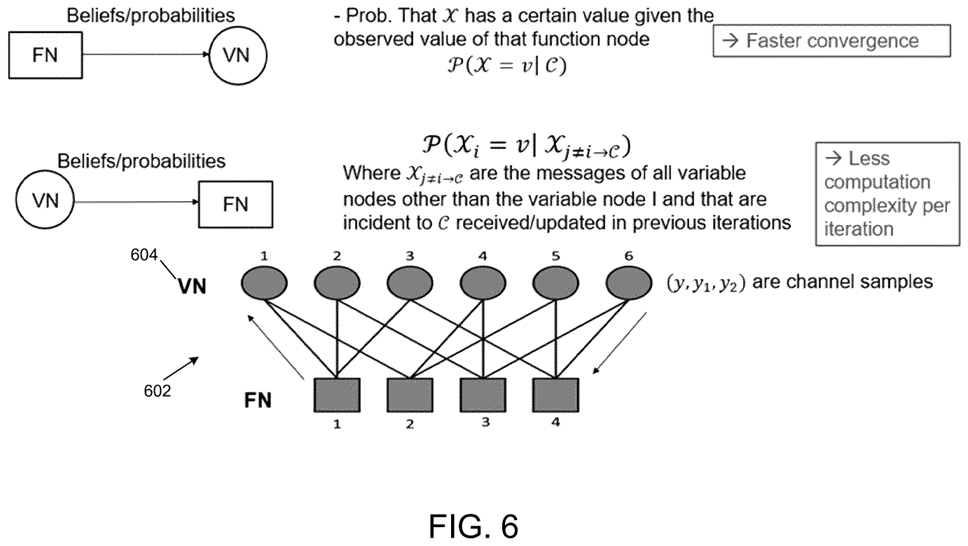

FIG. 6 illustrates an example of MPA complexity reduction gains, in accordance with aspects of the present disclosure. In one embodiment, the receiver could be composed of a post-coder that enables the retrieval of the different streams and FG-based detector. The output of the least connected FG 602, which could be in a first implementation a high likelihood probability of one of the VNs 604, could be fed to the next most connected FG 602, which allows complexity reduction of each computation per iteration.

In an alternate embodiment, expectation propagation (EP) messages could be exchanged between VNs and FNs. In this case, the convergence of the iterative detector could be made even faster since the EP messages of some VNs are determined using the least connected FGs associated with a known receiving antenna. These known EP messages could then be inserted into the most connected FGs associated with different receiving antenna elements.

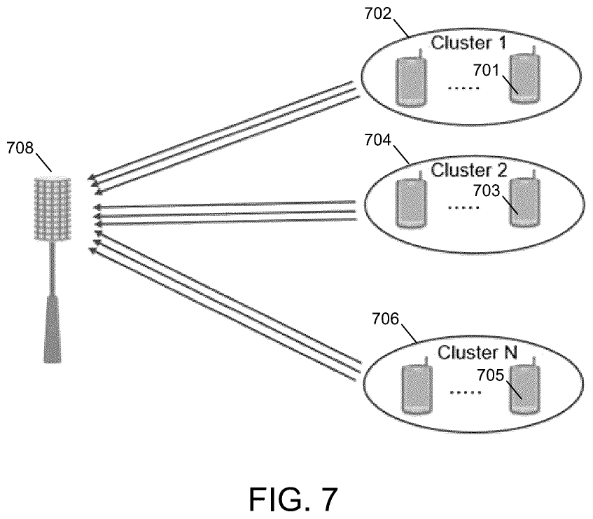

According to the third embodiment, different MU-MIMO spatial layers and multiplexed layers could be grouped in different clusters. FIG. 7 illustrates an example of MU-MIMO SCMA clustering, in accordance with aspects of the present disclosure. In this case, each cluster 702-706 could be assigned a precoding matrix designed based on the channel conditions. The overall system is equivalent to a MIMO system with different transmitting antennas representing the multiplexed UEs within the same cluster.

According to the first implementation, the same Rx antennas at the BS 708 could be associated with different UE clusters 702-706, where clusters include multiplexed UEs 701-705 over the same or different resources. In this case, several FG-based detection schemes could be implemented in a parallel manner, which enables the detection of multiple SCMA codewords simultaneously.

In a second implementation, each cluster 702-706 might be associated with different REs, for example, different OFDM tones. In this case, REs associated with each cluster are orthogonal to one another. A special case of precoding e.g., beamforming, could be performed by each cluster of multiplexed users. Different beams may be received from the same cluster at the Rx antennas of the BS. Each beam is associated with an FG-based detector and the receiver/BS could start by detecting variable nodes in least connected FGs and then introducing the high likelihoods of the detected VNs to the most connected FGs.

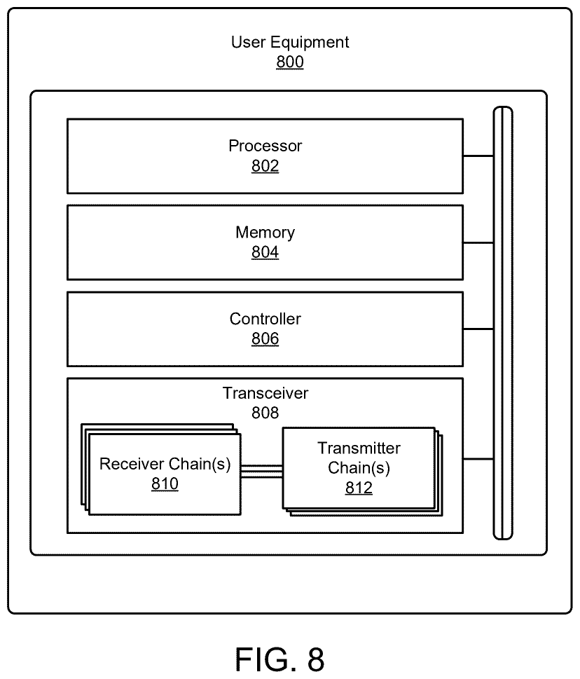

FIG. 8 illustrates an example of a UE 800 in accordance with aspects of the present disclosure. The UE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the UE 800 to perform various functions of the present disclosure.

The memory 804 may include volatile or non-volatile memory. The memory 804 may store computer-readable, computer-executable code including instructions when executed by the processor 802 cause the UE 800 to perform various functions described herein. The code may be stored in a non-transitory computer-readable medium such the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the UE 800 to perform one or more of the functions described herein (e.g., executing, by the processor 802, instructions stored in the memory 804). For example, the processor 802 may support wireless communication at the UE 800 in accordance with examples as disclosed herein. The UE 800 may receive a precoding matrix for enabling a plurality of combinations of streams of multiplexed layers, encode a signal using the precoding matrix, the signal combined with signals from a plurality of different UEs associated with the multiplexed layers, and transmit the encoded signal.

The controller 806 may manage input and output signals for the UE 800. The controller 806 may also manage peripherals not integrated into the UE 800. In some implementations, the controller 806 may utilize an operating system such as iOS®, ANDROID®, WINDOWS®, or other operating systems. In some implementations, the controller 806 may be implemented as part of the processor 802.

In some implementations, the UE 800 may include at least one transceiver 808. In some other implementations, the UE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas for receiving the signal over the air or wireless medium. The receiver chain 810 may include at least one amplifier (e.g., a low-noise amplifier (LNA)) configured to amplify the received signal. The receiver chain 810 may include at least one demodulator configured to demodulate the received signal and obtain the transmitted data by reversing the modulation technique applied during transmission of the signal. The receiver chain 810 may include at least one decoder for decoding and processing the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

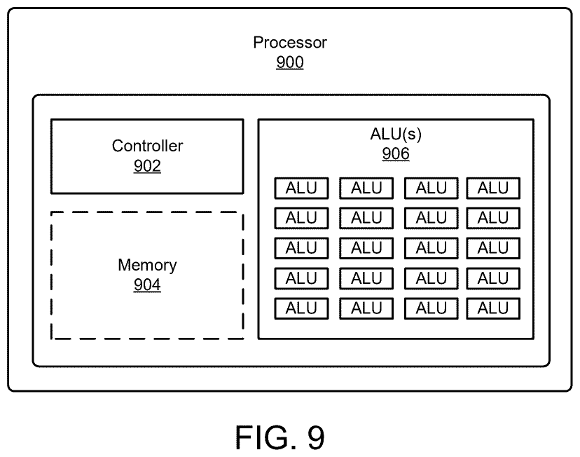

FIG. 9 illustrates an example of a processor 900 in accordance with aspects of the present disclosure. The processor 900 may be an example of a processor configured to perform various operations in accordance with examples as described herein. The processor 900 may include a controller 902 configured to perform various operations in accordance with examples as described herein. The processor 900 may optionally include at least one memory 904, which may be, for example, an L1/L2/L3 cache. Additionally, or alternatively, the processor 900 may optionally include one or more arithmetic-logic units (ALUs) 906. One or more of these components may be in electronic communication or otherwise coupled (e.g., operatively, communicatively, functionally, electronically, electrically) via one or more interfaces (e.g., buses).

The processor 900 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 900) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 902 may be configured to manage and coordinate various operations (e.g., signaling, receiving, obtaining, retrieving, transmitting, outputting, forwarding, storing, determining, identifying, accessing, writing, reading) of the processor 900 to cause the processor 900 to support various operations in accordance with examples as described herein. For example, the controller 902 may operate as a control unit of the processor 900, generating control signals that manage the operation of various components of the processor 900. These control signals include enabling or disabling functional units, selecting data paths, initiating memory access, and coordinating timing of operations.

The controller 902 may be configured to fetch (e.g., obtain, retrieve, receive) instructions from the memory 904 and determine subsequent instruction(s) to be executed to cause the processor 900 to support various operations in accordance with examples as described herein. The controller 902 may be configured to track memory address of instructions associated with the memory 904. The controller 902 may be configured to decode instructions to determine the operation to be performed and the operands involved. For example, the controller 902 may be configured to interpret the instruction and determine control signals to be output to other components of the processor 900 to cause the processor 900 to support various operations in accordance with examples as described herein. Additionally, or alternatively, the controller 902 may be configured to manage flow of data within the processor 900. The controller 902 may be configured to control transfer of data between registers, arithmetic logic units (ALUs), and other functional units of the processor 900.

The memory 904 may include one or more caches (e.g., memory local to or included in the processor 900 or other memory, such RAM, ROM, DRAM, SDRAM, SRAM, MRAM, flash memory, etc. In some implementations, the memory 904 may reside within or on a processor chipset (e.g., local to the processor 900). In some other implementations, the memory 904 may reside external to the processor chipset (e.g., remote to the processor 900).

The memory 904 may store computer-readable, computer-executable code including instructions that, when executed by the processor 900, cause the processor 900 to perform various functions described herein. The code may be stored in a non-transitory computer-readable medium such as system memory or another type of memory. The controller 902 and/or the processor 900 may be configured to execute computer-readable instructions stored in the memory 904 to cause the processor 900 to perform various functions. For example, the processor 900 and/or the controller 902 may be coupled with or to the memory 904, the processor 900, the controller 902, and the memory 904 may be configured to perform various functions described herein. In some examples, the processor 900 may include multiple processors and the memory 904 may include multiple memories. One or more of the multiple processors may be coupled with one or more of the multiple memories, which may, individually or collectively, be configured to perform various functions herein.

The one or more ALUs 906 may be configured to support various operations in accordance with examples as described herein. In some implementations, the one or more ALUs 906 may reside within or on a processor chipset (e.g., the processor 900). In some other implementations, the one or more ALUs 906 may reside external to the processor chipset (e.g., the processor 900). One or more ALUs 906 may perform one or more computations such as addition, subtraction, multiplication, and division on data. For example, one or more ALUs 906 may receive input operands and an operation code, which determines an operation to be executed. One or more ALUs 906 be configured with a variety of logical and arithmetic circuits, including adders, subtractors, shifters, and logic gates, to process and manipulate the data according to the operation. Additionally, or alternatively, the one or more ALUs 906 may support logical operations such as AND, OR, exclusive-OR (XOR), not-OR (NOR), and not-AND (NAND), enabling the one or more ALUs 906 to handle conditional operations, comparisons, and bitwise operations.

The processor 900 may support wireless communication in accordance with examples as disclosed herein. The processor 900 may create a precoding matrix for enabling a plurality of combinations of streams of multiplexed layers at a plurality of receiving antennas, wherein the plurality combinations of streams are associated with a plurality of user equipment UEs; transmit the precoding matrix to the plurality of UEs associated with the multiplexed layers; detect a plurality of signals at the plurality of receiving antennas using a factor graph-based detection algorithm, wherein the plurality of signals are encoded using the precoding matrix; and decode the plurality of signals based at least in part on the precoding matrix.

In one embodiment, the processor 900 is configured to detect the multiplexed layers in an order starting from a combination of variable nodes associated with a least connected factor graph followed by a combination of variable nodes associated with a most connected factor graph. In one embodiment, the processor 900 is configured to insert a likelihood associated with variable nodes from the least connected factor graph into subsequent connected factor graphs to enable convergence of a message passing algorithm and reduce computational complexity of each iteration of the factor graph-based detection algorithm.

In one embodiment, the processor 900 is configured to exchange messages between variable nodes and function nodes of a factor graph, and wherein the variable nodes are associated with the plurality of UEs, and the function nodes are associated with one or more orthogonal REs. In one embodiment, the precoding matrix is performed over SCMA multiplexed layers.

In one embodiment, the SCMA multiplexed layers are encoded using sparse codebooks and wherein each of the plurality of UEs is associated with a different sparse codebook. In one embodiment, a quantity of combinations of streams is bounded by a channel matrix rank.

In one embodiment, the processor 900 is configured to multiply rows of the precoding matrix by the plurality of signals of each of the plurality of UEs associated with the multiplexed layers. In one embodiment, the precoding matrix comprises a linear precoding matrix or a non-linear precoding matrix.

In one embodiment, the precoding matrix is created based on a CSI associated with the NE satisfying an accuracy threshold. In one embodiment, the plurality of UEs is divided into one or more clusters such that different clusters of the plurality of UEs are associated with different precoding matrices and different receiving antennas.

In one embodiment, the different clusters of the plurality of UEs are associated with different REs. In one embodiment, the plurality of signals are received as one signal corresponding to a superposition of the plurality of signals from the multiplexed layers based on the precoding matrix. In one embodiment, the precoding matrix is based on a singular value decomposition of a channel matrix, matched filtering, maximum ratio transmission, zero forcing, dirty paper coding, or a combination thereof.

In one embodiment, the processor 900 is configured to receive a precoding matrix for enabling a plurality of combinations of streams of multiplexed layers, encode a signal using the precoding matrix, the signal combined with signals from a plurality of different UEs associated with the multiplexed layers, and transmit the encoded signal.

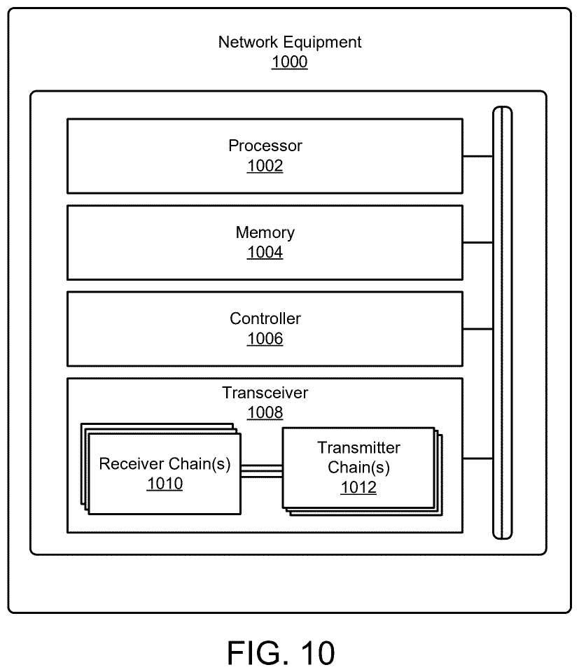

FIG. 10 illustrates an example of a NE 1000 in accordance with aspects of the present disclosure. The NE 1000 may include a processor 1002, a memory 1004, a controller 1006, and a transceiver 1008. The processor 1002, the memory 1004, the controller 1006, or the transceiver 1008, or various combinations thereof or various components thereof may be examples of means for performing various aspects of the present disclosure as described herein. These components may be coupled (e.g., operatively, communicatively, functionally, electronically, electrically) via one or more interfaces.

The processor 1002, the memory 1004, the controller 1006, or the transceiver 1008, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1002 may include an intelligent hardware device (e.g., a general-purpose processor, a DSP, a CPU, an ASIC, an FPGA, or any combination thereof). In some implementations, the processor 1002 may be configured to operate the memory 1004. In some other implementations, the memory 1004 may be integrated into the processor 1002. The processor 1002 may be configured to execute computer-readable instructions stored in the memory 1004 to cause the NE 1000 to perform various functions of the present disclosure.

The memory 1004 may include volatile or non-volatile memory. The memory 1004 may store computer-readable, computer-executable code including instructions when executed by the processor 1002 cause the NE 1000 to perform various functions described herein. The code may be stored in a non-transitory computer-readable medium such the memory 1004 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1002 and the memory 1004 coupled with the processor 1002 may be configured to cause the NE 1000 to perform one or more of the functions described herein (e.g., executing, by the processor 1002, instructions stored in the memory 1004). For example, the processor 1002 may support wireless communication at the NE 1000 in accordance with examples as disclosed herein.

In one embodiment, the NE 1000 is configured to create a precoding matrix for enabling a plurality of combinations of streams of multiplexed layers at a plurality of receiving antennas, wherein the plurality combinations of streams are associated with a plurality of user equipment UEs; transmit the precoding matrix to the plurality of UEs associated with the multiplexed layers; detect a plurality of signals at the plurality of receiving antennas using a factor graph-based detection algorithm, wherein the plurality of signals are encoded using the precoding matrix; and decode the plurality of signals based at least in part on the precoding matrix.

In one embodiment, the NE 1000 is configured to detect the multiplexed layers in an order starting from a combination of variable nodes associated with a least connected factor graph followed by a combination of variable nodes associated with a most connected factor graph. In one embodiment, the NE 1000 is configured to insert a likelihood associated with variable nodes from the least connected factor graph into subsequent connected factor graphs to enable convergence of a message passing algorithm and reduce computational complexity of each iteration of the factor graph-based detection algorithm.

In one embodiment, the NE 1000 is configured to exchange messages between variable nodes and function nodes of a factor graph, and wherein the variable nodes are associated with the plurality of UEs, and the function nodes are associated with one or more orthogonal REs. In one embodiment, the precoding matrix is performed over SCMA multiplexed layers.

In one embodiment, the SCMA multiplexed layers are encoded using sparse codebooks and wherein each of the plurality of UEs is associated with a different sparse codebook. In one embodiment, a quantity of combinations of streams is bounded by a channel matrix rank.

In one embodiment, the NE 1000 is configured to multiply rows of the precoding matrix by the plurality of signals of each of the plurality of UEs associated with the multiplexed layers. In one embodiment, the precoding matrix comprises a linear precoding matrix or a non-linear precoding matrix.

In one embodiment, the precoding matrix is created based on a CSI associated with the NE satisfying an accuracy threshold. In one embodiment, the plurality of UEs is divided into one or more clusters such that different clusters of the plurality of UEs are associated with different precoding matrices and different receiving antennas.

In one embodiment, the different clusters of the plurality of UEs are associated with different REs. In one embodiment, the plurality of signals are received as one signal corresponding to a superposition of the plurality of signals from the multiplexed layers based on the precoding matrix. In one embodiment, the precoding matrix is based on a singular value decomposition of a channel matrix, matched filtering, maximum ratio transmission, zero forcing, dirty paper coding, or a combination thereof.

The controller 1006 may manage input and output signals for the NE 1000. The controller 1006 may also manage peripherals not integrated into the NE 1000. In some implementations, the controller 1006 may utilize an operating system such as iOS®, ANDROID®, WINDOWS®, or other operating systems. In some implementations, the controller 1006 may be implemented as part of the processor 1002.

In some implementations, the NE 1000 may include at least one transceiver 1008. In some other implementations, the NE 1000 may have more than one transceiver 1008. The transceiver 1008 may represent a wireless transceiver. The transceiver 1008 may include one or more receiver chains 1010, one or more transmitter chains 1012, or a combination thereof.

A receiver chain 1010 may be configured to receive signals (e.g., control information, data, packets) over a wireless medium. For example, the receiver chain 1010 may include one or more antennas for receiving the signal over the air or wireless medium. The receiver chain 1010 may include at least one amplifier (e.g., a low-noise amplifier (LNA)) configured to amplify the received signal. The receiver chain 1010 may include at least one demodulator configured to demodulate the received signal and obtain the transmitted data by reversing the modulation technique applied during transmission of the signal. The receiver chain 1010 may include at least one decoder for decoding and processing the demodulated signal to receive the transmitted data.

A transmitter chain 1012 may be configured to generate and transmit signals (e.g., control information, data, packets). The transmitter chain 1012 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1012 may also include at least one power amplifier configured to amplify the modulated signal to an appropriate power level suitable for transmission over the wireless medium. The transmitter chain 1012 may also include one or more antennas for transmitting the amplified signal into the air or wireless medium.

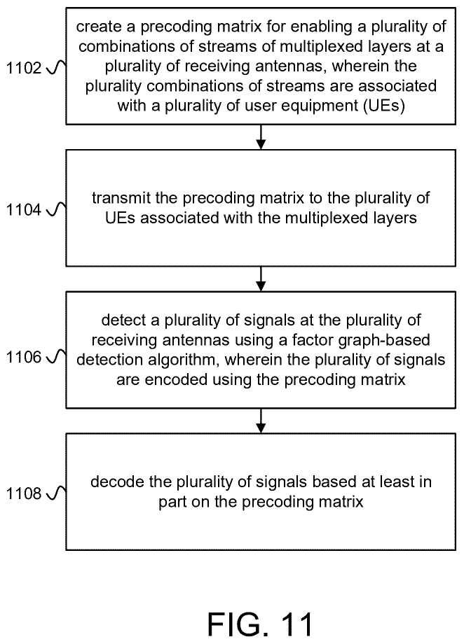

FIG. 11 illustrates a flowchart of a method in accordance with aspects of the present disclosure. The operations of the method may be implemented by a NE as described herein. In some implementations, the NE may execute a set of instructions to control the function elements of the NE to perform the described functions.

At 1102, the method may create a precoding matrix for enabling a plurality of combinations of streams of multiplexed layers at a plurality of receiving antennas, wherein the plurality combinations of streams are associated with a plurality of UEs. The operations of 1102 may be performed in accordance with examples as described herein. In some implementations, aspects of the operations of 1102 may be performed by a NE as described with reference to FIG. 10.

At 1104, the method may transmit the precoding matrix to the plurality of UEs associated with the multiplexed layers. The operations of 1104 may be performed in accordance with examples as described herein. In some implementations, aspects of the operations of 1104 may be performed by a NE as described with reference to FIG. 10.

At 1106, the method may detect a plurality of signals at the plurality of receiving antennas using a factor graph-based detection algorithm, wherein the plurality of signals are encoded using the precoding matrix. The operations of 1106 may be performed in accordance with examples as described herein. In some implementations, aspects of the operations of 1106 may be performed by a NE as described with reference to FIG. 10.

At 1108, the method may decode the plurality of signals based at least in part on the precoding matrix. The operations of 1108 may be performed in accordance with examples as described herein. In some implementations, aspects of the operations of 1108 may be performed by a NE as described with reference to FIG. 10.

It should be noted that the method described herein describes A possible implementation, and that the operations and the steps may be rearranged or otherwise modified and that other implementations are possible.

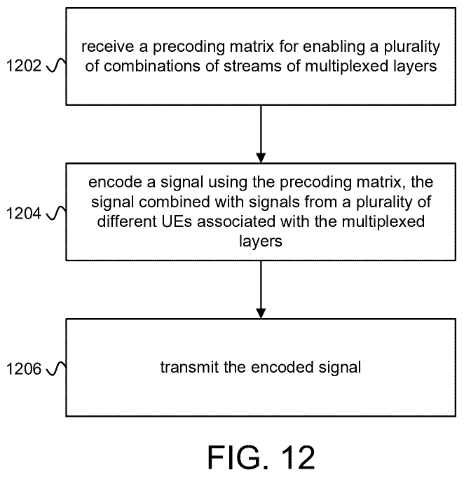

FIG. 12 illustrates a flowchart of a method in accordance with aspects of the present disclosure. The operations of the method may be implemented by a UE as described herein. In some implementations, the UE may execute a set of instructions to control the function elements of the UE to perform the described functions.

At 1202, the method may receive a precoding matrix for enabling a plurality of combinations of streams of multiplexed layers. The operations of 1202 may be performed in accordance with examples as described herein. In some implementations, aspects of the operations of 1202 may be performed by a UE as described with reference to FIG. 8.

At 1204, the method may encode a signal using the precoding matrix, the signal combined with signals from a plurality of different UEs associated with the multiplexed layers. The operations of 1204 may be performed in accordance with examples as described herein. In some implementations, aspects of the operations of 1204 may be performed by a UE as described with reference to FIG. 8.

At 1206, the method may transmit the encoded signal. The operations of 1206 may be performed in accordance with examples as described herein. In some implementations, aspects of the operations of 1206 may be performed by a NE as described with reference to FIG. 8.

It should be noted that the method described herein describes A possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A network equipment (NE) for wireless communication, comprising:
at least one memory; and
at least one processor coupled with the at least one memory and configured to cause the NE to:
create a precoding matrix for enabling a plurality of combinations of streams of multiplexed layers at a plurality of receiving antennas, wherein the plurality combinations of streams are associated with a plurality of user equipment (UEs);
transmit the precoding matrix to the plurality of UEs associated with the multiplexed layers;
detect a plurality of signals at the plurality of receiving antennas using a factor graph-based detection algorithm, wherein the plurality of signals are encoded using the precoding matrix; and
decode the plurality of signals based at least in part on the precoding matrix.

2. The NE of claim 1, wherein the at least one processor is configured to cause the NE to detect the multiplexed layers in an order starting from a combination of variable nodes associated with a least connected factor graph followed by a combination of variable nodes associated with a most connected factor graph.

3. The NE of claim 2, wherein the at least one processor is configured to cause the NE to insert a likelihood associated with variable nodes from the least connected factor graph into subsequent connected factor graphs to enable convergence of a message passing algorithm and reduce computational complexity of each iteration of the factor graph-based detection algorithm.

4. The NE of claim 3, wherein the at least one processor is configured to cause the NE to exchange messages between variable nodes and function nodes of a factor graph, and wherein the variable nodes are associated with the plurality of UEs, and the function nodes are associated with one or more orthogonal resource elements (REs).

5. The NE of claim 1, wherein the precoding matrix is performed over sparse code multiple access (SCMA) multiplexed layers.

6. The NE of claim 5, wherein the SCMA multiplexed layers are encoded using sparse codebooks and wherein each of the plurality of UEs is associated with a different sparse codebook.

7. The NE of claim 6, wherein a quantity of combinations of streams is bounded by a channel matrix rank.

8. The NE of claim 1, wherein the at least one processor is configured to cause the NE to multiply rows of the precoding matrix by the plurality of signals of each of the plurality of UEs associated with the multiplexed layers.

9. The NE of claim 1, wherein the precoding matrix comprises a linear precoding matrix or a non-linear precoding matrix.

10. The NE of claim 1, wherein the precoding matrix is created based on a channel state information (CSI) associated with the NE satisfying an accuracy threshold.

11. The NE of claim 1, wherein the plurality of UEs is divided into one or more clusters such that different clusters of the plurality of UEs are associated with different precoding matrices and different receiving antennas.

12. The NE of claim 11, wherein the different clusters of the plurality of UEs are associated with different resource elements (REs).

13. The NE of claim 1, wherein the plurality of signals are received as one signal corresponding to a superposition of the plurality of signals from the multiplexed layers based on the precoding matrix.

14. The NE of claim 1, wherein the precoding matrix is based on a singular value decomposition of a channel matrix, matched filtering, maximum ratio transmission, zero forcing, dirty paper coding, or a combination thereof.

15. A processor for wireless communication, comprising:
at least one controller coupled with at least one memory and configured to cause the processor to:
create a precoding matrix for enabling a plurality of combinations of streams of multiplexed layers at a plurality of receiving antennas, wherein the plurality combinations of streams are associated with a plurality of user equipment (UEs);
transmit the precoding matrix to the plurality of UEs associated with the multiplexed layers;
detect a plurality of signals at the plurality of receiving antennas using a factor graph-based detection algorithm, wherein the plurality of signals are encoded using the precoding matrix; and
decode the plurality of signals based at least in part on the precoding matrix.

16. The processor of claim 15, wherein the at least one controller is configured to cause the processor to detect the multiplexed layers in an order starting from a combination of variable nodes associated with a least connected factor graph followed by a combination of variable nodes associated with a most connected factor graph.

17. The processor of claim 16, wherein the at least one controller is configured to cause the processor to insert a likelihood associated with variable nodes from the least connected factor graph into subsequent connected factor graphs to enable convergence of a message passing algorithm and reduce computational complexity of each iteration of the factor graph-based detection algorithm.

18. The processor of claim 17, wherein the at least one controller is configured to cause the processor to exchange messages between variable nodes and function nodes of a factor graph, and wherein the variable nodes are associated with the plurality of UEs and the function nodes are associated with one or more orthogonal resource elements (REs).

19. A method of a user equipment (UE), comprising:
creating a precoding matrix for enabling a plurality of combinations of streams of multiplexed layers at a plurality of receiving antennas, wherein the plurality combinations of streams are associated with a plurality of user equipment (UEs);
transmitting the precoding matrix to the plurality of UEs associated with the multiplexed layers;
detecting a plurality of signals at the plurality of receiving antennas using a factor graph-based detection algorithm, wherein the plurality of signals are encoded using the precoding matrix; and
decoding the plurality of signals based at least in part on the precoding matrix.

20. A user equipment (UE) for wireless communication, comprising:
at least one memory; and
at least one processor coupled with the at least one memory and configured to cause the UE to:
receive a precoding matrix for enabling a plurality of combinations of streams of multiplexed layers;
encode a signal using the precoding matrix, the signal combined with signals from a plurality of different UEs associated with the multiplexed layers; and
transmit the encoded signal.
